(19) United States
(12) Patent Application Publication
(10) Pub. No.: US 2010/0086666 A1
(43) Pub. Date: Apr. 8, 2010

(54) Alcoholic beverage

(76) Inventor: Andrew Adelman, San Bruno, CA (US)

Correspondence Address: Klaus P. Stoffel;Wolff & Samson PC, One Boland Drive, West Orange, NJ, 07052, US

(21) Appl. No.: 12/286,997

(22) Filed: Oct. 3, 2008

(51) Int. Cl. C12G 3/00

(52) U.S. Cl. 426/592

(57) ABSTRACT

An alcoholic beverage made up of distilled alcohol, deionized water and a protein. The protein is present in a concentration of 2-25 grams per liter of beverage.

### BACKGROUND OF THE INVENTION

The present invention relates to alcoholic distilled spirits, and particularly to an alcoholic beverage with additives.

A number of references exist which disclose alcoholic beverages with additives of various types. Among these are the following references:

U.S. Patent Application Publication No. US 2006/0110519 discloses a low-glycemic alcoholic beverage containing alcohol and a low-glycemic component which is capable of extracting an essence of a food stuff. The purpose of the extracting component is to enhance the flavor of the beverage by extracting an essence of a food, such as fruits, vegetables, nuts and plants.

U.S. Pat. No. 6,468,566 discloses a ferulic acid decarboxylase that is introduced into a yeast used in the production of distilled liquors for improving the flavor of the distilled liquor.

U.S. Pat. No. 4,957,765 discloses cream based liqueurs that have improved emulsion stability. The process includes preparing a protein premix by dissolving citric acid and caseinate in water. The protein premix is mixed with cream so that globules are formed, and then a spirit premix containing spirits, carbohydrate and water is added to form a product mixture that is homogenized.

U.S. Pat. No. 4,086,366 discloses a process for producing vodka of improved quality by removing and extracting proteinacious components.

U.S. Pat. No. 1,066,084 discloses alcoholic beverages in which a salt or peptide of amino acid adds a flavor enhancing characteristic to the beverage.

### SUMMARY AND DESCRIPTION OF THE INVENTION

It is an object of the present invention to provide an alcoholic beverage with a smoother taste and that gives some nutritional benefit to the consumer. Pursuant to this object, and others which will become apparent hereafter, one aspect of the present invention resides in an alcoholic beverage with added protein.

In one embodiment of the invention, protein is added in a concentration of 2-25 grams per liter of beverage, preferably 15-20 grams per liter. A possible protein for use is casein hydrolysate.

The casein hydrolysate is produced from milk protein casein. Casein is enzimatically hydrolyzed into peptides and the absorbed amino acids are integrated into proteins necessary for maintaining human bodies or are used as an energy source.

The proteins used in the present invention are water and alcohol soluble and provide better taste and mouth feel to the consumer. The commercially prepared protein hydrolysate gives the advantage that the protein is already cleaved into smaller portions known as peptides which are easier and more rapidly absorbed than the whole, intact protein.

A further benefit of the present invention is that the side effects of alcohol consumption are reduced by the ingestion of protein. In other words, since protein is ingested with the alcohol there is the possibility that the side effects of consuming the alcohol are reduced.

Normal protein is a polypeptide with up to thousands of units of amino acids. The casein hydrolysate contained in the beverage of the present invention only has short chain peptides, which have an average length that is less than 4 amino acids and are water soluble. The small peptides of the casein hydrolysate are taken quickly and directly into the gut and released into the blood stream without digestion. The alcohol from the beverage eventually enters the blood stream as well. Since the protein enters the blood stream prior to the alcohol it will lead to some neutralizing of the potency of the alcohol. This in turn should lead to fewer hangovers, a lesser loss of motor skills and may as well reduce possible damage to internal organs, such as the liver.

In a further embodiment of the invention, the alcoholic beverage to which the protein is added is triple distilled from corn and is free of congeners (i.e. methydol, aldehydes and amyl alcohols). Furthermore, the vodka should be 40% alcohol by volume, or 80 proof.

Essentially, the alcoholic beverage of the present invention is made up of three components, triple distilled alcohol from corn, casein hydrolysate and deionized water.

This combination of elements provides two fold benefit, namely an alcoholic beverage that is smoother than conventional alcoholic beverages, as well as reducing the effects of the alcohol on the consumer due to the presence of the protein which, as previously discussed, is absorbed faster than the alcohol.

It is understood that vodka is only given as an example and that the invention applies to equally to other distilled alcohols.

Although the present invention has been described in relation to particular embodiments thereof, many other variations and modifications and other uses will become apparent to those skilled in the art. It is preferred, therefore, that the present invention be limited but by the specific disclosure herein, but only by the appended claims.

1. An alcoholic beverage comprising protein.

2. The alcoholic beverage according to claim 1, wherein the protein is present in a concentration of 2-25 grams per liter of beverage.

3. The alcoholic beverage according to claim 2, wherein the protein is present in a concentration of 15-20 grams per liter of beverage.

4. The alcoholic beverage according to claim 1, wherein the beverage is vodka.

5. The alcoholic beverage according to claim 1, wherein the protein is water and alcohol soluble.

6. The alcoholic beverage according to claim 5, wherein the protein is casein hydrolysate.

7. The alcoholic beverage according to claim 4, wherein the vodka is triple distilled and free of cogeners.

8. The alcoholic beverage according to claim 1, comprising triple distilled alcohol from corn, casein hydrolysate and deionized water.

9. The alcoholic beverage according to claim 8, wherein the casein hydrolysate is in a concentration of 2-25 grams per liter of beverage.

10. The alcoholic beverage according to claim 9, wherein the beverage is vodka.

11. A process for producing an alcoholic beverage, comprising the steps of:
providing an alcohol;
providing deionized water;
providing a protein; and
combining the alcohol, deionized water and protein to produce an alcoholic beverage with a protein concentration of 2-25 grams per liter of beverage.

12. The process according to claim 11, wherein the alcohol is distilled from corn.

13. The process according to claim 11, wherein the protein is casein hydrolysate.

14. The alcoholic beverage according to claim 2, wherein the protein is present in a concentration of 2-20 grams per liter of beverage.

15. The alcoholic beverage according to claim 1, wherein the protein is hydrolyzed casein.

16. The process of claim 11, wherein the protein concentration is 2-20 grams per liter of beverage.

17. The process according to claim 11, wherein the protein is hydrolyzed casein.
